(19) United States
(12) Patent Application Publication
(10) Pub. No.: US 2007/0222755 A1
(43) Pub. Date: Sep. 27, 2007

(54) Combined mouse and laser pointer

(75) Inventor: Kiyoshi Kajihara, Gunma (JP)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Hosiden Corporation, Osaka (JP)

(21) Appl. No.: 11/728,059

(22) Filed: Mar. 22, 2007

(30) Foreign Application Priority Data
Mar. 24, 2006 (JP) 2006-082805

(51) Int. Cl. G09G 5/08

(52) U.S. Cl. 345/163

(57) ABSTRACT

There is provided a combined mouse and laser pointer that has a positional information input section provided on the bottom surface, a outer casing in which a laser light outlet through which a laser beam is output to the outside of the outer casing is provided, a mouse function section, a laser pointer function section, and a function selecting section which controls enablement and disablement of the mouse function section and the laser pointer function section, wherein the function selecting section selects and enables either or both of the mouse function section and the laser pointer function section at the same time.

### TECHNICAL FIELD

The present invention relates to a combination of a computer mouse and a laser pointer that is supplied with electric power through a USB port.

### BACKGROUND ART

A mouse, which is a computer input device, that includes a laser pointer function has been known. An example of such a mouse includes a mouse disclosed in Patent literature 1 shown in FIG. 9. The mouse 91 is stick-shaped. A USB cable 92 to be connected to a computer, not shown, is drawn from one end of the stick-shaped mouse 91. A laser emitter 93 is provided on the other end of the stick-shaped mouse 91 and a laser emission switch 94 is provided on one side of the mouse 91. Input of the distance and direction of movement of the mouse on a flat surface, which is an intended function of the mouse, is performed by rotating with a fingertip a rotating ball 95 provided on the edge on the laser emitter 93 side of the mouse 91. In particular, the stick-shaped mouse 91 is held by the right hand, for example, and the rotating ball 95 is operated with the pad of the right thumb to input the distance and direction of movement of the mouse 91, thereby causing the apparatus to function as a mouse. To cause the apparatus to function as a laser pointer, the laser emission switch 94 is pressed with the right middle finger or annular finger. In this way, a presenter in a presentation can cause the apparatus to function as a mouse and laser pointer with a one-handed operation. Instead of using a power supply 96, the laser pointer may be supplied with power through a USB port, not shown, through the USB cable 92.
Patent literature 1: Japanese Patent Application Laid-Open No. 2005-38362 (FIG. 1)

Such a combined mouse and laser pointer as described above is convenient for a presenter to operate in a presentation but is tricky to use as an input device for computer. That is, because of its unique stick shape of the mouse, the apparatus is not easy to use when it is used as a mouse in such work as data editing. Furthermore, the convergence of the laser beam emitted from the laser emitter 93 is so high and powerful that, if entering human eyes, the laser beam may damage the eyes. However, no safety feature has been provided that prevents a laser beam from being directed into human eyes by an erroneous operation or misuse. During using the apparatus as a mouse, the user does not have adequate consciousness that they are also holding a laser pointer, and can accidentally operate the laser emission switch 94 while directing the laser emitter 93 into human eyes. The risk is especially high with the conventional-art apparatus described above because of the stick shape of the mouse 91.

### SUMMARY OF THE INVENTION

The present invention has been made in light of these circumstances and an object of the present invention is to provide a combined mouse and laser pointer that is easy to use as a mouse as well and includes a safety feature.

A laser pointer and mouse combination according to the present invention includes:

an outer casing having a flat bottom surface and a curved upper and side surface and having a positional information input section provided on the bottom surface said outer casing having a laser light outlet for outputting a laser light to the outside;

a mouse function section including a push button section provided on the upper and side surface of the outer casing and generating switch information, a mouse information generating section which generates mouse information from information including the switch information and the positional information provided from the positional information input section and, a USB interface provided inside the outer casing and outputting the mouse information through a USB cable;

a laser pointer function section including a laser pointer light emitting section which uses Vbus provided through the USB cable as power to emit light and outputs the light through the laser light outlet and a laser pointer light emission switch which turns on and off light emission from the laser pointer light emitting section; and

a function selecting section which controls selection between operations of the mouse function section and the laser pointer function section.

### BRIEF DESCRIPTION OF THE DRAWINGS

FIG. 1 shows a situation in which a combined mouse and laser pointer according to the present invention is used;

FIG. 2A is a plan view of the combined mouse and laser pointer according to the present invention;

FIG. 2B is a front elevation view of the combined mouse and laser pointer;

FIG. 2C is a right side view of the combined mouse and laser pointer;

FIG. 3 shows a configuration of a basic embodiment of the present invention;

FIG. 4 is a block diagram showing a specific exemplary functional configuration of a combined mouse and laser pointer according to a first embodiment of the present invention;

FIG. 5 is a block diagram showing a specific exemplary functional configuration of a combined mouse and laser pointer according to a second embodiment of the present invention;

FIG. 6 shows a function selecting section of a combined mouse and laser pointer according to a third embodiment of the present invention;

FIG. 7A is an enlarged front elevation view of a laser light outlet 25 shown in FIG. 2B with a closed shutter 26;

FIG. 7B is an enlarged front elevation view of the laser light outlet 25 with the shutter 26 open;

FIG. 7C is a cross-sectional view taken along line 7C-7C in FIG. 7A;

FIG. 8A is an external view of a positional information input section of an optical mouse;

FIG. 8B shows an example in which a laser light outlet 25 and a shutter 26 are provided on the side opposite to the side from which a USB cable 21 is drawn; and

FIG. 9 shows a combined mouse and laser pointer disclosed in Patent literature 1.

### DERAILED DESCRIPTION OF PREFERRED EMBODIMENTS

Embodiments of the present invention will be described with reference to the accompanying drawings, in which like elements are labeled like reference numerals to avoid overlapping descriptions.

### [Situation where a Combined Mouse and Laser Pointer of the Invention is Used]

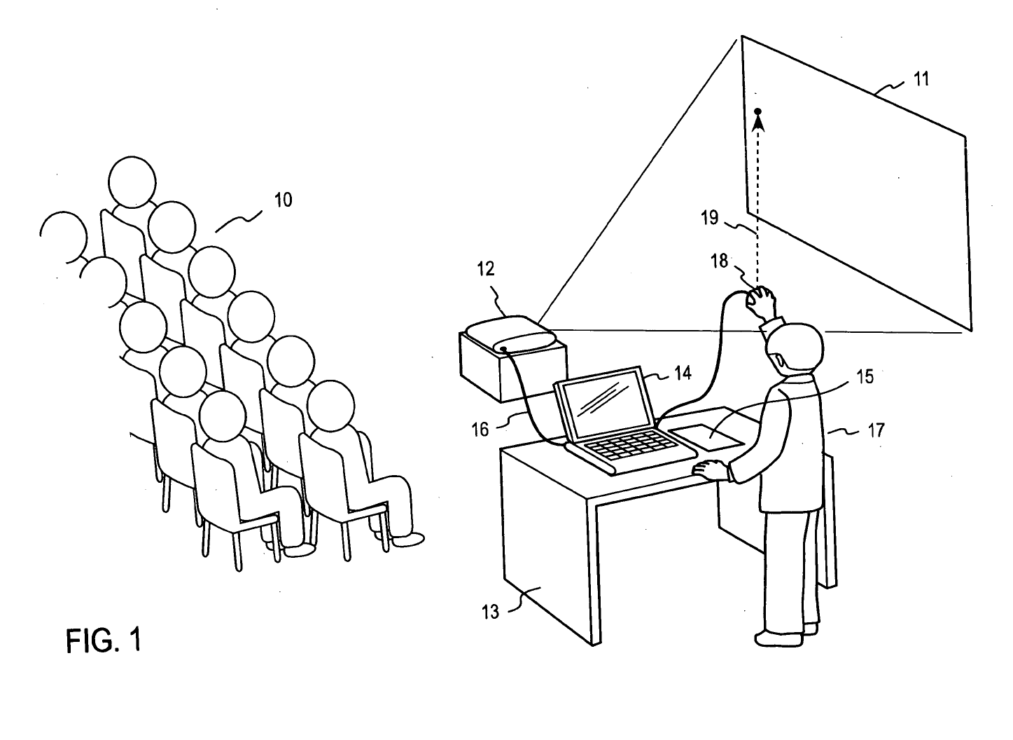

FIG. 1 shows a situation in which a combined mouse and laser pointer according to the present invention is used. A screen 11 is positioned in front of an audience 10 and a projector 12 is located between the audience 10 and the projection screen 11. A lecture table 13 is positioned diagonally in front of the audience 10 and a computer 14 and a mouse pad 15 are placed on it. The projector 12 is connected to a video output terminal of the computer 14 through a video cable 16 and an image displayed on the display of the computer 14 is projected on the screen 11. The presenter 17 operates a combined mouse and laser pointer 18 according to the present invention to project a laser beam 19 on an item on the image projected on the screen 11 to point the item. After pointing, the presenter 17 puts back the combined mouse and laser pointer 18 on the mouse pad 15 and uses its mouse function to update the image on the screen 11 or operate the computer 14.

In this way, the combined mouse and laser pointer according to the present invention enables smooth switching between operation of the computer 14 and operation of the laser pointer. Furthermore, the laser pointer function is disabled by a function selecting section when the apparatus is used as mouse only, as will be described later. Thus, a highly safe combined mouse and laser pointer can be implemented.

### [Exemplary Appearance of the Combined Mouse and Laser Pointer of the Invention]

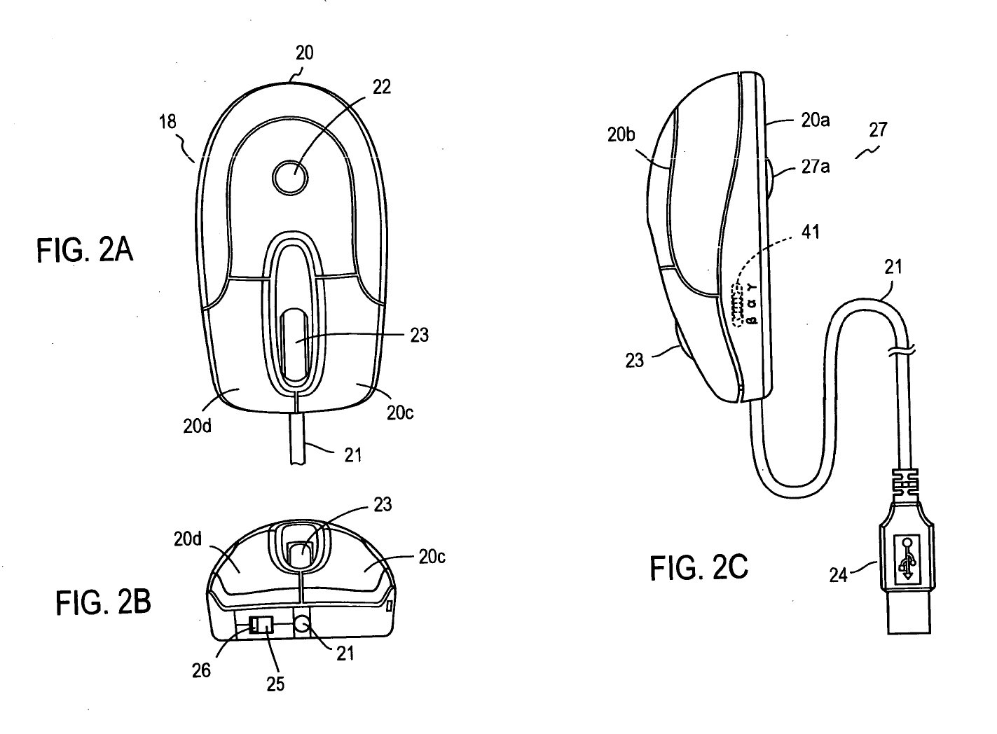

FIGS. 2A, 2B, and 2C show an exemplary appearance of a combined mouse and laser pointer according to the present invention. FIG. 2A is a plan view of the combined mouse and laser pointer 18 (a portion of a USB cable 21 is shown), FIG. 2B is a front elevation view of the apparatus, and FIG. 2C is a right side view of the apparatus with the USB cable 21 and a USB plug 24.

The combined mouse and laser pointer has a generally oval plan view. The USB cable 21 is drawn from one end of the generally oval outer casing 20. The USB plug 24 is provided on the other end of the USB cable 21 to be inserted in a USB port of a computer. The outer casing 20 includes four exterior components: a lower casing 20a and an upper casing 20b, and a first push button 20c and a second push button 20d provided on one side along the length of the apparatus for inputting switch information. The outer side of the outer casing 20 is designed to be easily covered by the palm of one hand and lifted. More particularly, a cross-section of the upper casing 20b perpendicular to the length of the upper casing 20b is generally arc-shaped and the radius r of the arc on the first and second push buttons 20c, 20d side is gradually and more significantly changed toward the edges than the radius r on the opposite side. That is, the apex of the arc is located in the center roughly at the c(enter of the upper casing 20b and the radius r of the arc on the side from which the USB cable 21 is drawn is greater than the radius of the arc on the opposite side. The outer surface of the outer casing 20 is gently inclined toward the USB cable 21 side in such a manner that the entire outer casing 20 can be held in the palm. When the outer casing 20 is held in the right palm, for example, the index finger is positioned on the first push button 20c and the middle finger is positioned on the second button 20d. A laser pointer light emission switch 22 is located roughly at the apex of the upper casing 20b. Provided between the first push button 20c and the second push button 20d is a wheel 23 used for scrolling up and down a display screen on the display of a computer. The wheel can be turned with the tip of the index finger, for example. An input section for inputting positional information is provided on the bottom surface of the outer casing 20, which in this example is a ball that rotates when the combined mouse and laser pointer 18 is horizontally moved on a mouse pad. A portion of the rotating ball 27a is projected out from the surface of the lower casing 20a. The end of the length of the plan shape of the outer casing 20 shown in FIG. 2A from which the USB cable 21 is drawn is generally straight; the other end is generally arc-shaped.

The USB cable 21 is drawn from the center of the lower casing 20a on one end of the outer casing 20. A laser light outlet 25 is provided at the interface between the upper casing 20b and the lower casing 20a and a shutter 26 is provided for the laser light outlet 25 that opens and closes.

Since the outer shape of the laser pointer of the embodiment is similar to a typical mouse, the apparatus is easy to use as a mouse. The appearance of the laser pointer of the embodiment is not limited to the one shown in FIGS. 2A, 2B, and 2C. Any outer appearances are included in the scope of the invention that allow a user to hold the entire outer casing 20 in the palm of one hand when the lower casing 20 is placed on a surface such as a mouse pad, and to lift the apparatus 18 by the hand. The position of the laser light outlet 25 is not limited to the position shown in FIG. 2B. The laser light outlet 25 may be provided on the side opposite to the USB cable side. While the first and second push buttons 20c, 20d and the wheel 23 are provided as means for inputting switch information, an arrangement in which only a single push button is provided is also possible.

### Basic Embodiment of the Invention

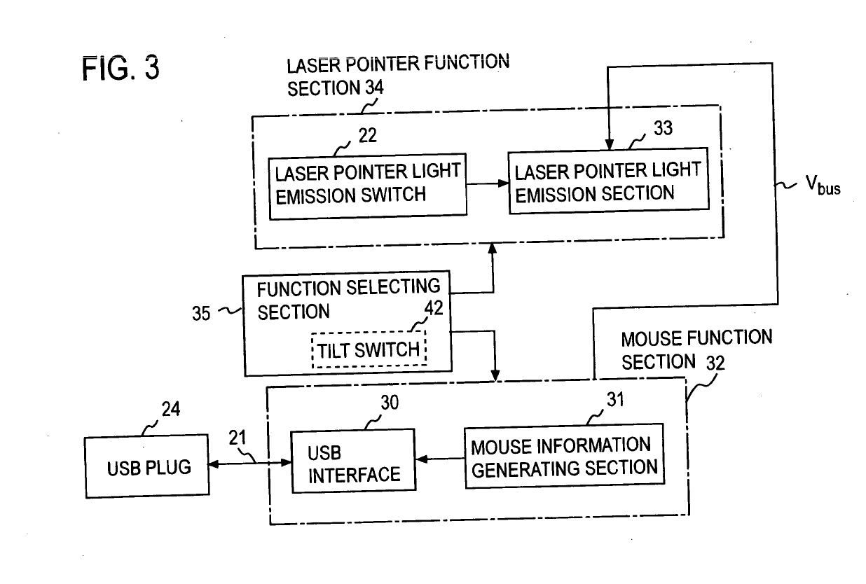

A functional configuration of a basic embodiment of the present invention is shown in FIG. 3 and its operation will be described below. The basic embodiment shown in FIG. 3 mainly consists of a mouse function section 32, a laser pointer function section 34, and function selecting section 35. A USB interface 30 which is a part of the mouse function section 32 is connected to a USB port of a computer, not shown, through a USB cable 21 using a USB plug 24. A mouse information generating section 31 which is another part of the mouse function section 32 converts positional information input through the positional information input section 27 shown in FIG. 2C and switch information generated through operations of the first push button 20c, second push button 20d, and wheel 23 shown in FIGS. 2A, 2B, and 2C into electric signals and outputs them as mouse information. The USB interface 30 converts mouse information provided from the mouse information generating section 31 into a serial bit stream compliant with the USB standard and inputs it in a computer, not shown.

According to the USB standard, electric power can be supplied from a host such as a computer to a device, a peripheral device such as a mouse. The power source can supply an electricity of 5 V/100 mA (or 500 mA) and is referred to as Vbus. The USB interface 30 and the mouse information generating section 31 operate on the Vbus power supply. The USB interface 30 converts an input signal from the mouse information generating section 31 into two signals D+ and D− used for serial communication based on differential operation and inputs them into a computer. A clock signal used for synchronization of the serial communication is obtained by encoding the D+ or D− signal using Non Return to Zero Invert (NRZI). That is, the USB plug 24 is connected to the computer through four terminals. Further description of the USB interface 30 will be omitted here since it is not a substantial part of the present invention.

Vbus of the mouse function section 32 obtained through the USB port is supplied to laser pointer light emitting section 33 and is also used as a power supply for the laser pointer. Operation of the laser pointer light emitting section 33 is controlled by the laser pointer light emission switch 22 mentioned above. The laser pointer light emission switch 22 and the laser pointer light emitting section 33 constitute the laser pointer function section 34.

Operations of the mouse function section 32 and the laser pointer function section 34 are controlled by the function selecting section 35. The function selecting section 35 selects and enables either or both of the mouse function section 32 and the laser pointer function section 34.

The function selecting section 35 allows a user to select and use either or both of the laser pointer function and the mouse function with both functions in mind. This can reduce the risk of accidentally operating the laser pointer light emission switch 22 while the laser pointer light emitting section 33 is directed into human eyes, which can occur with conventional combined mouse and laser pointers. Operation of the function selecting section 35 will be described with respect to a specific example of the function selecting section 35.

### First Embodiment

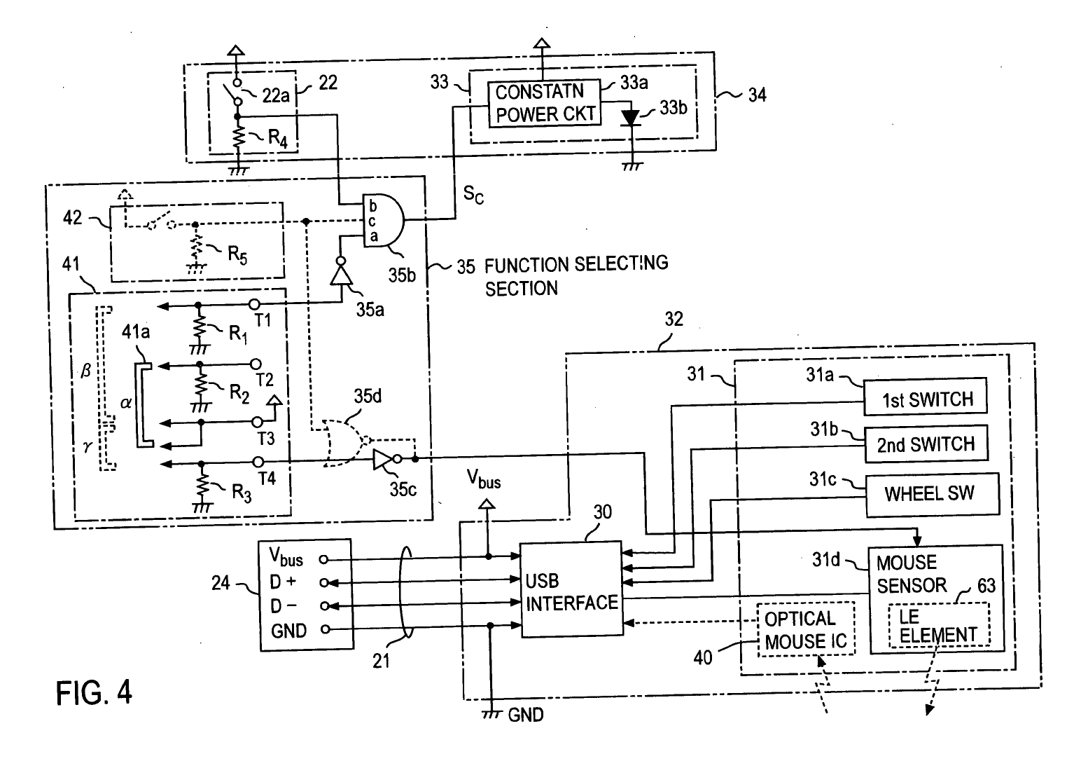

FIG. 4 is a block diagram showing a specific functional configuration of a combined mouse and laser pointer according to a first embodiment of the present invention. A mouse information generating section 31 includes a first switch 31a operated by a first push button 20c, a second switch 31b operated by a second push button 20d, a wheel switch 31c which converts the rotation of a wheel 23 to a pulse signal, and a mouse sensor 31d which converts positional information input through a positional information input section 27 into an electric signal. Output signals from these components are input into a USB interface 30. The mouse sensor 31d may be designed to convert movement of rotating ball 27a into a pulse signal representing the distances of the: mechanical movements in the X-axis and Y-axis directions. In the case of an apparatus generally called an optical mouse which optically reads image information from a surface such as a mouse pad and obtains the distance and direction of movement from the image information, the mouse sensor 3 Id may include a light emitting element 63 which irradiates the mouse pad with light and an optical mouse integrated circuit 40 which obtains an image from reflected light and applies image processing to the image to calculate the distance and direction of movement. In the case of the optical mouse, an optical mouse integrated circuit 40 including an image pickup device and signal processing and interface sections is provided in the mouse sensor 31d as indicated by a dashed box in FIG. 4. In addition, a light emitting element 63 for irradiating a mouse pad with light is provided in the mouse sensor 31d.

The laser pointer light emitting section 33 includes a laser diode 33b and a constant power circuit 33a which drives the laser diode 33b with a constant electric power. The constant power circuit 33a sets a driving power for driving the laser diode 33b and drives the laser diode 33b with the set power in accordance with a light emission control signal Sc from the laser pointer light emission switch 22.

The main element of the function selecting section 35 in this example is a three-position sliding switch 41. The sliding switch 41 is a typical switch in which one sliding electrode 41 a can take one of three positions. The sliding switch 41 is provided on one side of the lower casing 20a of the outer casing 20, for example, as indicated by a dashed curve in FIG. 2C. The sliding electrodes at three positions α, β, and γ are shown in different sizes due to limits of drawing. A common electrode T3 of the sliding switch 41 is connected to Vbus. The other electrodes T1, T2, and T4 are grounded through pull-down resistances R₁, R₂, and R₃, respectively. Electrode T1 is connected to an input terminal a of an AND gate 35b through an inverter 35a. Connected to another input terminal b of the AND gate 35b is the output terminal of the laser pointer light emission switch 22 which is grounded through a pull-down resistance R₄. The output of the AND gate 35b is provided to a control terminal of the constant power circuit 33a.

When the sliding electrode 41a is at position α, electrode T1 of the sliding switch 41 is at a low level (ground voltage). Accordingly, the input terminal a of the AND gate 35b is at a high level (Vbus voltage) and therefore the AND gate 35b is open (enabled). While the sliding electrode 41a is in this state and the laser pointer light emission switch 22 is in the on state, the AND gate 35b outputs a high-level signal and the constant power circuit 33a causes the laser diode 33b to emit light.

When the sliding electrode 41 is slid to position β, the common electrode T3 connected to Vbus is connected with electrode T1 and therefore the input terminal a of the AND gate 35b goes low and the AND gate 35b is disabled. In this state, the laser diode 33b does not emit light even if the laser pointer light emission switch 22 is turned on, therefore the combined mouse and laser pointer functions as mouse only.

When the, sliding electrode 41a is slid to position γ, the common electrode T3 connected to Vbus is connected with electrode T4. Electrode T4 is connected to a control terminal of the mouse sensor 31d through an inverter 35c. When electrode T4 goes high, the control terminal of the mouse sensor 31d becomes low and stops sensing of positional information. Then the combined mouse and laser pointer functions as laser pointer only.

In summary, when the sliding electrode 41a is at position α, both of the mouse function section 32 and the laser pointer function section 34 are active. When the sliding electrode 41a is at position β, the combined mouse and laser pointer functions as mouse only. When the sliding electrode 41a is at position γ, the combined mouse and laser pointer functions as laser pointer only. The functions of the combined mouse and laser pointer can be selected by the function selecting section 35 in this way, a user can consciously switch between the laser pointer function and the mouse function. This can reduce the risk of accidentally operating on the laser pointer light emission switch 22 while the laser pointer light emitting section 33 is directed to human eyes, which can occur with a conventional combined mouse and laser pointer.

As an additional safety feature, the attitude of the combined mouse and laser pointer may be detected and used for controlling operation of the mouse function section 32 and the laser pointer function section 34. A configuration for this safety feature is indicated by a dashed box in FIG. 4. For example, a tilt switch 42 can be used to detect the attitude. The tilt switch 42 may be a switch in which a movable metal ball is placed in a cylinder and the metal ball moved by a tilt brings a contact provided at one end of the cylinder into conduction. When the USB cable 21 side of the outer casing 20 is raised higher than the other side, an output from an output terminal of the tilt switch 42 which is grounded through a pull-down resistance R₅ goes high. That is, when the combined mouse and laser pointer is kept horizontal on a mouse pad, its output is low whereas when the laser light outlet 25 side is raised, it goes high. The output terminal of the tilt switch 42 is connected to an input terminal c of the AND gate 35b. Provision of the tilt switch 42 prevents the combined mouse and laser pointer from functioning as the laser pointer unless the laser light outlet 25 side of the outer casing 20 is raised higher than the opposite side, even if the sliding electrode 41a is at position α or γ and the laser pointer function section 34 is operable.

The output terminal of the tilt switch 42 is connected to the control terminal of the mouse sensor 31 d through an NOR gate 35d provided instead of the inverter 35c. Therefore, when the laser light outlet 25 side of the outer casing 20 is raised higher than the other side and the apparatus is not to be as the mouse, the mouse function section 32 can be disabled. This control has an advantageous effect: if the mouse is an optical mouse, light emission from a light emitting element 63 of the mouse sensor 31d can be prevented. Thus, the audiences' eyes in a presentation can be more concentrated on the screen. The reason will be described below.

It is assumed here that the mouse is an optical mouse, the sliding electrode 41a is at position α, and both the mouse function section 32 and the laser pointer function section 34 are operable. When the presenter 17 making a presentation in front of an audience 10 directs the lower casing 20a of the combined mouse and laser pointer 18 toward the audience as shown in the situation in FIG. 1 and described, a point of bright light from the light emitting element 63 of the mouse sensor 31d comes in the audience's sight in addition to a point of light on the screen pointed by the presenter. This can move the audience's viewpoint from the screen and consequently interfere with the audience's concentration. By providing the tilt switch 42 to prevent the light emitting element 63 from emitting light, the worry of diverting the audience's attention can be eliminated. A specific way to reactivate the disabled light emitting element 63 to emit light will be described later.

The attitude of the outer casing 20 is used as a factor for controlling functions in this way, a safer laser pointer can be implemented. In the case of an optical mouse, decrease in the level of concentration of the audience can also be avoided.

### Second Embodiment

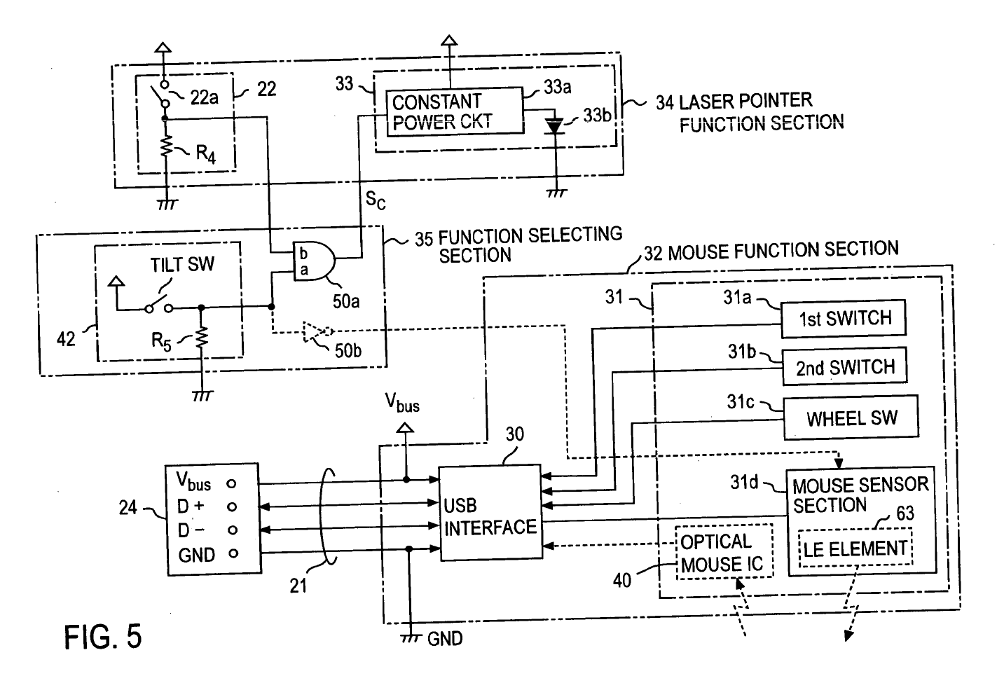

FIG. 5 shows a second embodiment of the present invention. The second embodiment is the same as the first embodiment except that the sliding switch 41 of the function selecting section 35 is omitted. That is, the sliding switch is eliminated to keep a mouse function section 32 and a laser pointer function section 34 operable all the time, and function selection is made by a tilt switch 42. The output terminal of the tilt switch 42 is connected to an input terminal a of an AND gate 50a. Connected to an input terminal b of the AND gate 50a is the output terminal of a laser pointer light emission switch 22. The AND gate 50a opens when the laser light outlet 25 side of the combined mouse and laser pointer 18 is raised as described above. Accordingly, light emission from a laser diode 33b can be activated by operating a laser pointer light emission switch 22 while the end is kept raised. By inverting an output signal from the tilt switch 42 by an inverter 50b as indicated by a dashed line in the function selecting section 35 and using the inverted signal as a control signal for the mouse sensor 31d, operation of the mouse information generating section 31 can be disabled during this operation.

Simply by detecting and using the attitude of the combined mouse and laser pointer to control operations of the mouse function and the laser pointer function in this way, the level of safety of the laser pointer can be improved.

### Third Embodiment

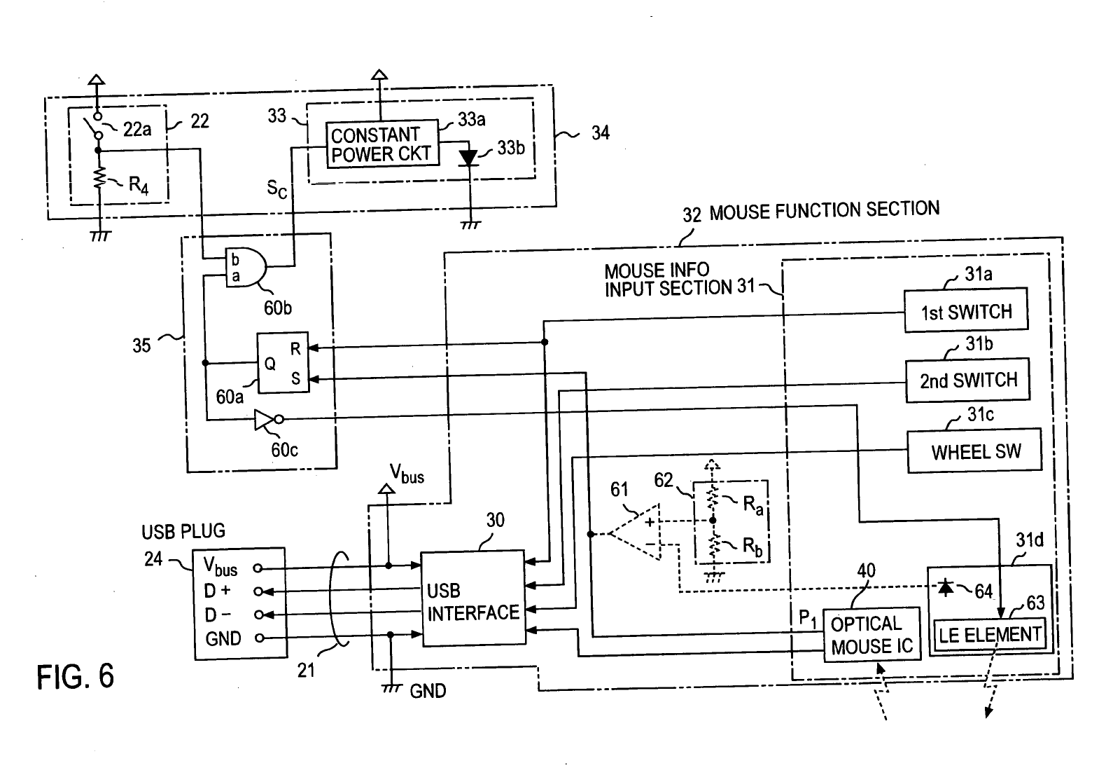

FIG. 6 shows a third embodiment in which a different function selecting section of a combined mouse and laser pointer is used instead of a tilt switch. The operation will be described below. In the third embodiment, a function selecting section 35 detects and uses a reduction in the amount of reflected light of light emitted from a mouse sensor 31d of an optical mouse to control operation of a laser pointer function section 34 and a mouse function section 32. In the case of an optical mouse, the mouse sensor 31d includes a light emitting element 63. When the combined mouse and laser pointer 18 is raised off a mouse pad, for example, in order to use it as a pointer, the amount of reflected light entering an optical mouse integrated circuit 40 significantly decreases. In the third embodiment, such a variation in the amount of reflected light is detected and used for selecting one of the mouse function and the laser pointer function.

The optical mouse integrated circuit 40 includes an image pixel array, not shown, that detects reflected light, an ADC (Analog to Digital Convertor) that converts an analog output voltage from the image pixel array into a digital value, and a motion vector section that calculates the direction and distance of movement from the digital value, and has an output terminal P₁ whose output goes high when a voltage corresponding to the amount of reflected light detected by the mouse sensor 31d drops below a predetermined value. The output terminal P₁ is connected to a set terminal S of an R-S latch 60a constituting a function selecting section 35. An output Q from the R-S latch 60a is connected to an input terminal a of two-input AND gate 60b and is also connected to the control terminal of the mouse sensor 31d through an inverter 60c. The other input terminal of the two-input AND gate 60b is connected to a laser pointer light emission switch 22. The output terminal of the two-input AND gate 60b is connected to the control terminal of a laser pointer light emitting section 33. Connected to a reset terminal R of the R-S latch 60a is the output terminal of a first push button section 20c.

When a presenter lifts the combined mouse and laser pointer 18 in order to use it as a laser pointer, the output terminal P₁ of the optical mouse integrated circuit 40 goes high. Then, output Q from the R-S latch 60a is set to high. When output Q of the R-S latch 60a is set to high, the two-input AND gate 60b opens and enables operation of the laser pointer light emission switch 22. That is, the apparatus functions as a laser pointer. Since the output Q from the R-S latch 60a has been inverted by an inverter 60c and used as a control signal for a mouse sensor 31d, light emission of the light emitting element 63 of the mouse sensor 31d is disabled while the combined mouse and laser pointer is functioning as a laser pointer.

This state can be cleared by pressing the first push button section 20c once because the output terminal of the first push button section 20c is connected to the reset terminal R of the R-S latch 60a. With this simple operation, the operation of the mouse function section 32 can be reactivated. The control of reactivation of the mouse function section 32 can be implemented in the first and second embodiments described above as well. The reset signal of the R-S latch 60a may be switch information from a second switch 31b or a wheel switch 31c.

While the set signal for the R-S latch 60a is provided from the output terminal P₁ of the optical mouse integrated circuit 40, the set signal may be obtained by converting the amount of reflected light detected by a photodiode 64 in the mouse sensor 31d to a voltage and comparing by an operational amplifier 61 the voltage value with a reference voltage provided from a reference voltage generating section 62 including voltage divider resistances Ra and Rb indicated by a dashed box in FIG. 6 to detect decrease in the amount of reflected light, whereby the set signal is generated.

### [Structure of Shutter]

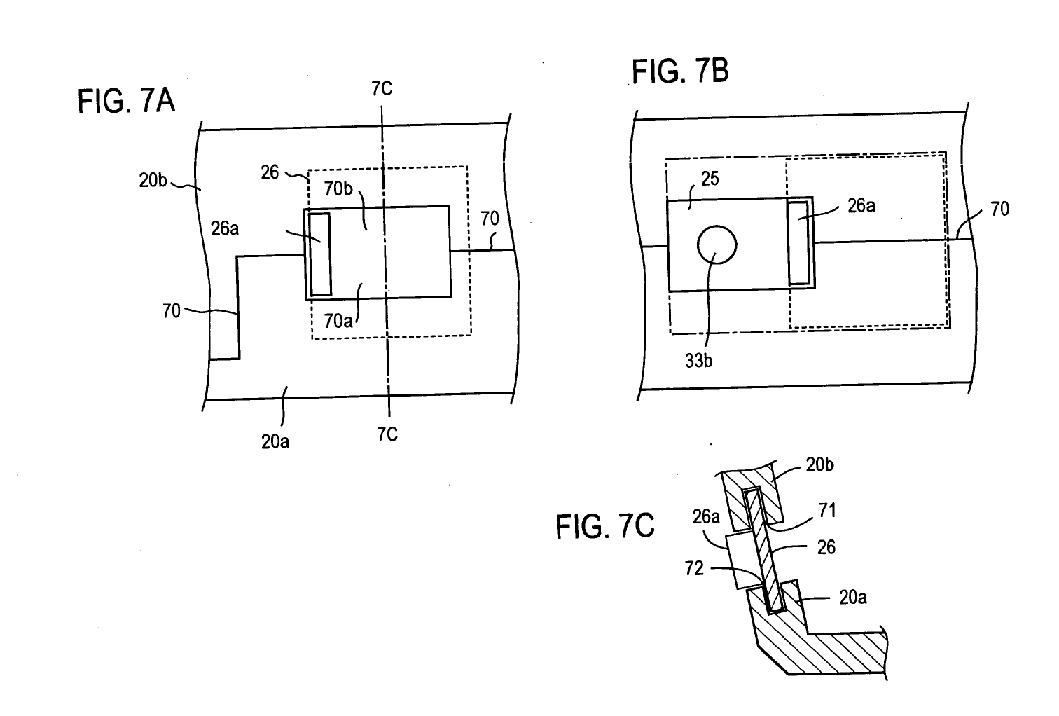

As will be seen from the description so far, the combined mouse and laser pointer according to the present invention is easy to use and safe because of the effects of the function selecting section 35. A shutter 26 may be provided for the laser light outlet 25 of the combined mouse and laser pointer as shown in FIG. 2B to further improve the level of safety. A structure of the shutter 26 is shown in FIGS. 7A, 7B, and 7C. FIG. 7A is an enlarged front elevation view of the laser light outlet 25 shown in FIG. 2B. FIG. 7A shows the shutter 26 in the closed state and FIG. 7B shows the shutter 26 in the open state. FIG. 7C is a cross-sectional view taken along line 7C-7C in FIG. 7A.

The laser light outlet 25 may be a square-shaped aperture and formed across an engage line 70. In particular, the laser light outlet 25 is divided into two. One portion is provided on the lower casing 20a side and the other on the upper casing 20b side. Square notches 70a and 70b are formed in the lower casing 20a and the upper casing 20b, respectively. Grooves 72 and 71 are formed in the upper and lower casings 20b and 20a along the inner periphery of the notches 70a and 70b. The shutter 26 is slighter larger than the square laser light outlet 25 and a grab 26a is formed at one end along an extension of the engage line 70. When the upper and lower casings 20b and 20a are fit together, the edges of the shutter 26 are inserted in the grooves 72 and 71 and the shutter 26 is attached along the extension of the engage line 70 in such a manner that the shutter 26 can move along the extension of the engage line 70. As shown in FIG. 7B, the portions of the grooves 72 and 71 on the side opposite to the grab 26a are formed deeper along the extension of the engage line 70 so that the shutter 26 can be moved into the deep grooves to open the laser light outlet 25. That is, the shutter 26 can be moved to fully close or open the laser light outlet 25 by operating the grab 26a with at fingertip.

Thus, projection of a laser beam can be prevented by the shutter 26 even while the function selecting section 35 enables the operation of the laser pointer function section 34. Therefore, the level of safety of the combined mouse and laser pointer can be further increased. That is, operation of the shutter 26 reminds a user of the laser pointer function of the apparatus and therefore the possibility of operating the laser pointer light emission switch 22 while the laser light outlet 25 is accidentally directed to human eyes can be reduced.

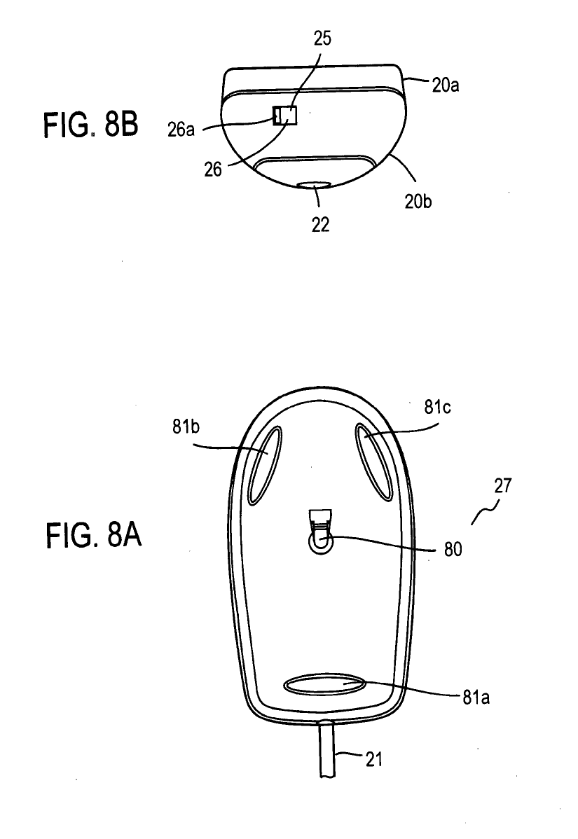

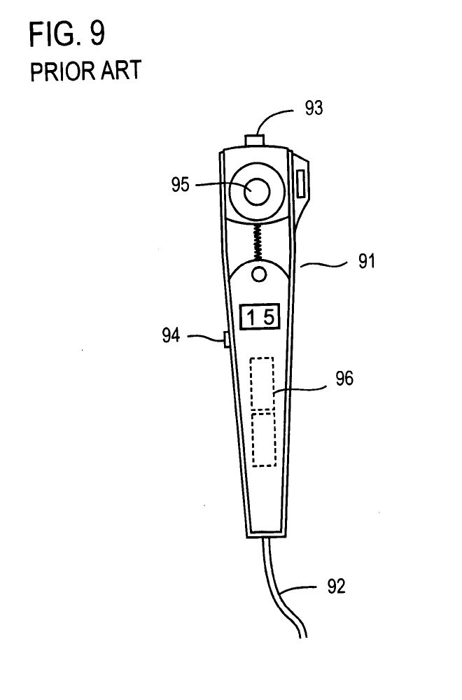

Since the function selecting section controls enablement and disablement of the laser pointer function section as has been described above, projection of a laser beam can be prevented while the apparatus is not used as a laser pointer. Therefore, a combined mouse and laser pointer that is safe and easy to use can be implemented. While the positional information input section 27 in the example shown in FIG. 2C has a rotating ball 27a, the present invention can be implemented in an optical mouse as mentioned above. An appearance of the positional information input section 27 of an optical mouse is shown in FIG. 8A. Provided in the positional information input section 27 of the optical mouse is a light inlet/outlet 80 through which a mouse pad, for example, is irradiated with light emitted from a light emitting element 63 and through which reflected light is taken in. An oval contact area reducing projection 81 a made from hard rubber, for example, is provided in parallel with the generally straight end of the outer casing 20 from which a USB cable 21 is drawn. Contact area reducing projections 81b and 81c of the same shape are provided both sides on the opposite end. The contact area reducing projections 81a, 81b, and 81c slightly project from the bottom surface of the lower casing 20a to prevent the entire bottom surface of the lower casing 20a from contacting a mouse pad or the like. FIG. 8B shows an example in which a laser light outlet 25 and a shutter 26 are provided on the side opposite to the side from which the USB cable 21 is drawn. In this example, when using the apparatus as a laser pointer, the USB cable 21 is positioned on the user's wrist side, the user can lightly operate the apparatus with feeling of a slightly reduced mass of the USB cable 21.

In the example described above in which the laser light outlet 25 is provided on the USB cable side, a user can smoothly switch between the mouse function and the pointer function without needing to move the hand off the combined mouse and laser pointer and reposition the hand as can be seen from FIG. 1 showing a situation where the apparatus is used. While the attitude of the apparatus is detected by using a tilt switch that turns on when the USB cable 21 side is raised higher than the other side in the example described above, the opposite attitude may be detected. Alternatively, two tilt switches may be provided so that both of the attitudes can be detected to control operation of the pointer. That is, an arrangement can be readily implemented in which the mouse function is enabled only when the attitude of the outer casing is horizontal.

In this way, various variations of the combined mouse and laser pointer are possible without departing from the scope of the inventive concept defined in the claims.

### EFFECTS OF THE INVENTION

As has been described, the combined mouse and laser pointer according to the present invention is easy to use as a mouse because it has a shape similar to a typical mouse designed to be covered by the palm of one hand and into which positional information is input from the bottom surface. Furthermore, a laser beam is not emitted if the laser pointer light emission switch is accidentally depressed, because the function selecting section prevents the laser pointer function section from functioning as a laser pointer. Thus, the combined mouse and laser pointer has an improved level of safety.

What is claimed is:

1. A combined mouse and laser pointer, comprising:
an outer casing having a flat bottom surface and a curved upper and side surface and having a positional information input section provided on the bottom surface, said outer casing having a laser light outlet for outputting a laser light to the outside;
a mouse function section including a push button section provided on the upper and side surface of the outer casing and generating switch information, a mouse information generating section which generates mouse information from information including the switch information and the positional information provided from the positional information input section and, a USB interface provided inside the outer casing and outputting the mouse information through a USB cable;
a laser pointer function section including a laser pointer light emitting section which uses Vbus provided through the USB cable as power to emit light and outputs the light through the laser light outlet and a laser pointer light emission switch which turns on and off light emission from the laser pointer light emitting section; and
a function selecting section which controls selection between operations of the mouse function section and the laser pointer function section.

2. A combined mouse and laser pointer according to claim 1, wherein the function selecting section comprises a tilt switch which detects a tilt of the outer casing to enable the laser pointer function section to operate.

3. A combined mouse and laser pointer according to claim 2, wherein:
the positional information input section comprises a light emitting element which emits light from inside the outer casing and an integrated circuit which generates positional information in response to reflected light; and
the function selecting section comprises a tilt switch which detects a pointing operation of the laser pointer and a section which disables light emission from the light emitting element in response to an output from the tilt switch indicating detection of a tilt of the tilt switch.

4. A combined mouse and laser pointer according to claim 1, wherein:
the positional information input section comprises a light emitting element which emits light from inside the outer casing and an integrated circuit which generates positional information in response to reflected light; and
the function selecting section comprises a tilt switch which detects a pointing operation of the laser pointer and a section which disables light emission from the light emitting element in response to an output from the tilt switch indicating detection of a tilt of the tilt switch.

5. A combined mouse and laser pointer according to claim 1, wherein:
the positional information input section comprises a light emitting element which emits light from inside the outer casing and an integrated circuit which generates positional information in response to reflected light; and
the function selecting section comprises a reflected light reduction detecting section which detects a reduction in the amount of the reflected light to a value below a predetermined value and a section which disables light emission from the light emitting element in response to an output from the reflected light reduction detecting section.

6. A combined mouse and laser pointer according to claim 5, wherein light emission by the light emitting element disabled on the basis of the switch information is re-enabled.

7. A combined mouse and laser pointer according to claim 5, wherein a shutter which close a laser light emission opening of the laser pointer light emitting section.

8. A combined mouse and laser pointer according to claim 4, wherein light emission by the light emitting element disabled on the basis of the switch information is re-enabled.

9. A combined mouse and laser pointer according to claim 3, wherein light emission by the light emitting element disabled on the basis of the switch information is re-enabled.

10. A combined mouse and laser pointer according to claim 2, wherein a shutter which close a laser light emission opening of the laser pointer light emitting section.

11. A combined mouse and laser pointer according to any of claim 1, wherein a shutter which close a laser light emission opening of the laser pointer light emitting section.
